(19) United States
(12) Patent Application Publication
(10) Pub. No.: US 2021/0219317 A1
(43) Pub. Date: Jul. 15, 2021

(54) SIGNAL TRANSMISSION METHOD, INDICATION METHOD FOR ANTENNA PANEL INFORMATION, APPARATUSES THEREOF AND SYSTEM

(71) Applicant: FUJITSU LIMITED, Kawasaki-shi (JP)

(72) Inventors: Zhe CHEN, Beijing (CN); Lei ZHANG, Beijing (CN); Xin WANG, Beijing (CN)

(73) Assignee: FUJITSU LIMITED, Kawasaki-shi (JP)

(21) Appl. No.: 17/213,690

(22) Filed: Mar. 26, 2021

Related U.S. Application Data
(63) Continuation of application No. PCT/CN2018/113077, filed on Oct. 31, 2018.

(51) Int. Cl. H04W 72/12

(52) U.S. Cl. CPC H04W 72/1268; H04W 72/1289

(57) ABSTRACT

A signal transmission method, an indication method for antenna panel information, apparatuses thereof and a system. In the signal transmission method, the terminal equipment transmits an uplink signal according to antenna panel information related to an uplink control channel resource, or when a condition related to higher layer signaling is satisfied (the higher layer signaling satisfies a related condition), the terminal equipment transmits the uplink signal according to the antenna panel information related to an uplink control channel resource. Thus, by indicating the antenna panel information related to the uplink control channel resource, the network device may indirectly indicate antenna panel information used in transmitting other uplink signals, thereby achieving joint indication of antenna panel information on different types of uplink signals, and saving resources.

### CROSS-REFERENCE TO RELATED APPLICATION

This application is a continuation application of International Application PCT/CN2018/113077 filed on Oct. 31, 2018 and designated the U.S., the entire contents of which are incorporated herein by reference.

### FIELD

This disclosure relates to the field of communication technologies, and in particular to a signal transmission method, an indication method for antenna panel information, apparatuses thereof and a system.

### BACKGROUND

In high-frequency communication scenarios, improving quality and throughput of communication transmission requires beamforming technology. Realization of beamforming technology requires use of massive antenna arrays. In a new radio system of a fifth generation mobile communication technology (5G-NR, 5 generation-new radio), due to the large number of antenna elements contained in an antenna array, these antenna elements are usually distributed in different antenna panels in the antenna design. For a terminal equipment, directions of multiple antenna panels are usually different. The advantage of such a design is that when the terminal equipment is in a mobile state, different antenna panels may maximize gains of receiving and/or transmitting signals in different directions, so that enhancing robustness of the terminal equipment in receiving and/or transmitting signals.

In existing technologies, the 5G-NR system has achieved beam indication for massive antenna arrays. In particular, a channel state to which a beam corresponds is obtained by measuring a reference signal; with the measurement of the reference signal and report of a measurement result, a network device may determine a beam used in receiving and/or transmitting signals by indicating the reference signal to which the beam corresponds.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in a 5G-NR system, neither report of beam measurement nor subsequent beam indication information contains information on antenna panels. This means that for a network device, the information on antenna panels of the terminal equipment is transparent. On and off of the antenna panels can only be adjusted by the terminal equipment on its own. However, when scheduling signaling of the network device cannot refer to the information on the antenna panels of the terminal equipment, the terminal equipment alone cannot optimally use the antenna panels by itself. This will cause unnecessary antenna panels to be on and increase energy consumption of the terminal equipment.

In addition, for uplink signals, they are generally transmitted via control channels (PUCCHs) and data channels (PUSCHs) or in forms of reference signals (such as SRSs), and a particular transmission mode is dependent on scheduling of the network device. As transmission of control channels, data channels and reference signals is independently scheduled, if network device directly indicates their antenna panel information, a basic method is that the network device indicates antenna panel information of the control channels, data channels and reference signals respectively. Indicating in this way brings an advantage that different types of uplink signals have respective great spatial direction flexibility in transmission. However, in consideration that the terminal equipment usually only uses one antenna panel when it is not moving or turning over at a high speed, still indicating antenna panel information of different types of uplink signals respectively by the network device in such a situation will waste communication resources.

In order to solve at least one of the above problems or other similar problems, embodiments of this disclosure provide a signal transmission method, an indication method for antenna panel information, apparatuses thereof and a system, so as to save indication bits (resources).

According to a first aspect of the embodiments of this disclosure, there is provided a signal transmission method, the method including:

transmitting an uplink signal by a terminal equipment according to antenna panel information related to an uplink control channel (PUCCH) resource.

According to a second aspect of the embodiments of this disclosure, there is provided an indication method for antenna panel information, the method including:

transmitting indication information by a network device to a terminal equipment, indicating the terminal equipment with antenna panel information related to a PUCCH resource, the terminal equipment transmitting an uplink signal according to the antenna panel information related to a PUCCH resource.

According to a third aspect of the embodiments of this disclosure, there is provided a signal transmission apparatus, configured in a terminal equipment, the apparatus including:

a transmitting unit configured to transmit an uplink signal according to antenna panel information related to an uplink control channel (PUCCH) resource.

According to a fourth aspect of the embodiments of this disclosure, there is provided an indication apparatus for antenna panel information, configured in a network device, the apparatus including:

a first transmitting unit configured to transmit indication information to a terminal equipment, indicating the terminal equipment with antenna panel information related to a PUCCH resource, the terminal equipment transmitting an uplink signal according to the antenna panel information related to a PUCCH resource.

According to a fifth aspect of the embodiments of this disclosure, there is provided a terminal equipment, including the apparatus as described in the third aspect.

According to a sixth aspect of the embodiments of this disclosure, there is provided a network device, including the apparatus as described in the fourth aspect.

According to a seventh aspect of the embodiments of this disclosure, there is provided a communication system, including the terminal equipment as described in the fifth aspect and the network device as described in the sixth aspect.

According to another aspect of the embodiments of this disclosure, there is provided a computer readable program, wherein when the program is executed in a terminal equipment, the program causes a computer to carry out the method as described in the first aspect in the terminal equipment.

According to a further aspect of the embodiments of this disclosure, there is provided a storage medium storing a computer readable program, wherein the computer readable program causes a computer to carry out the method as described in the first aspect in a terminal equipment.

According to yet another aspect of the embodiments of this disclosure, there is provided a computer readable program, wherein when the program is executed in a network device, the program causes a computer to carry out the method as described in the second aspect in the network device.

According to still another aspect of the embodiments of this disclosure, there is provided a storage medium storing a computer readable program, wherein the computer readable program causes a computer to carry out the method as described in the second aspect in a network device.

An advantage of the embodiments of this disclosure exists in that according to the embodiments of this disclosure, the network device may only need to indicate the antenna panel information related to the uplink control channel resource, joint indication of antenna panel information on different types of uplink signals (such a PUCCH, PUSCH, or an uplink reference signal) may be achieved, thereby saving indication bits (resources).

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of an embodiment of this disclosure;

FIG. 2 is a schematic diagram of the signal transmission method of Embodiment 1;

FIG. 3 is a schematic diagram of the indication method for antenna panel information of Embodiment 2;

FIG. 4 is a schematic diagram of the signal transmission apparatus of Embodiment 3;

FIG. 5 is a schematic diagram of the indication apparatus for antenna panel information of Embodiment 4;

FIG. 6 is a schematic diagram of the terminal equipment of Embodiment 5; and

FIG. 7 is a schematic diagram of the network device of Embodiment 6.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which may be expressed as a serving cell, and may be a macro cell or a pico cell, depending on a context of the term.

In the embodiments of this disclosure, the term “user equipment (UE)” refers to, for example, equipment accessing to a communication network and receiving network services via a network device, and may also be referred to as “terminal equipment (TE)”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Scenarios in the embodiments of this disclosure shall be described below by way of examples; however, this disclosure is not limited thereto.

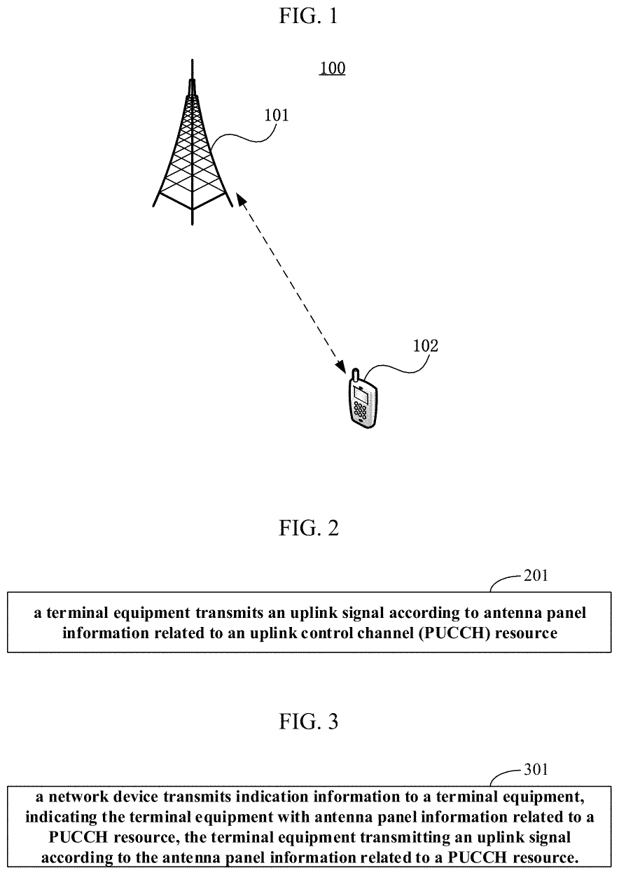

FIG. 1 is a schematic diagram of a communication system of an embodiment of this disclosure, in which a case where a terminal equipment and a network device are taken as examples is schematically shown. As shown in FIG. 1, a communication system 100 may include a network device 101 and a terminal equipment 102. For the sake of simplicity, description is given in FIG. 1 by taking one terminal equipment only as an example. For example, the network device 101 is the network device gNB in the NR system.

In the embodiment of this disclosure, existing traffics or traffics that may be implemented in the future may be performed between the network device 101 and the terminal equipment 102.

For example, such traffics may include but not limited to an enhanced mobile broadband (eMBB), massive machine type communication (MTC), and ultra-reliable and low-latency communication (URLLC), etc.

The terminal equipment 102 may transmit data to the network device 101, for example, in a granted or grant-free transmission mode. The network device 101 may receive data transmitted by one or more terminal equipments 102, and feed back information (such as acknowledgement ACK/non-acknowledgement NACK) to the terminal equipment 102, and the terminal equipment 102 may acknowledge terminating a transmission process according to the feedback information, or may further perform new data transmission, or may perform data retransmission.

Implementations of this disclosure shall be described below with reference to the accompanying drawings. These implementations are illustrative only, and are not intended to limit this disclosure.

### Embodiment 1

The embodiment of this disclosure provides a signal transmission method, applicable to a terminal equipment. FIG. 2 is a schematic diagram of the signal transmission method of this embodiment. Referring to FIG. 2, the method includes:

step 201: a terminal equipment transmits an uplink signal according to antenna panel information related to an uplink control channel (PUCCH) resource.

In step 201 of this embodiment, the terminal equipment transmits the uplink signal according to the antenna panel information related to the PUCCH resource. Hence, the network device may only need to indicate the antenna panel information related to the uplink control channel resource, joint indication of antenna panel information on different types of uplink signals (such a PUCCH, PUSCH, or an uplink reference signal) may be achieved, thereby saving indication bits (resources).

The uplink signal and PUCCH resource in step 201 of this embodiment shall be respectively described below.

As for the uplink signal in step 201 of this embodiment.

In this embodiment, the uplink signal may be an uplink reference signal, such as a periodic sounding reference signal (SRS), a semi-persistent SRS, and an aperiodic SRS, etc.; however, this embodiment is not limited thereto.

In this embodiment, the uplink signal may also be an uplink data channel (PUSCH). The uplink data channel (PUSCH) may be scheduled by downlink control information (DCI), and may also be transmitted according to configuration information, such as uplink transmission with configured grant Type 1, or uplink transmission with configured grant Type 2. The uplink transmission with configured grant Type 1 refers to that all resource allocation information of a PUSCH is configured by RRC signaling, and the terminal equipment transmits a corresponding PUSCH according to the configuration information. The uplink transmission with configured grant Type 2 refers to that a part of resource allocation information of a PUSCH is configured by RRC signaling, and the other part is indicated by specific DCI (such as DCI scrambled by a CS-RNTI). After receiving the above DCI, the terminal equipment transmits a corresponding PUSCH according to the configuration information and indication information in the above DCI. After the terminal equipment receives a specific DCI for deactivation, it stops transmitting the corresponding PUSCH.

In this embodiment, the DCI scheduling the above uplink data channel (PUSCH) may satisfy at least one of the following conditions that:

a format of the DCI is format 0_0 or format 0_1;

the DCI is scrambled by one of a cell radio network temporary identity (C-RNTI), a modulation and coding scheme cell radio network temporary identity (MCS-C-RNTI) and a random access radio network temporary identity (RA-RNTI); and

the DCI includes a field used for indicating a target PUCCH resource.

In this embodiment, the terminal equipment may receive the above DCI, and when the above DCI satisfies at least one of the above conditions, the terminal equipment may transmit the PUSCH according to the antenna panel information related to the PUCCH resource.

For example, when the format of the DCI is format 0_0 or format 0_1, the terminal equipment transmits the PUSCH scheduled by the DCI according to the antenna panel information related to the PUCCH resource. Here, the format of DCI is only an example, and this embodiment is not limited thereto.

For another example, when DCI is scrambled by one of the C-RNTI, MCS-C-RNTI and RA-RNTI, the terminal equipment transmits the PUSCH scheduled by the DCI according to the antenna panel information related to the PUCCH resource. Here, the scrambling method of the DCI is illustrative only, and this embodiment is not limited thereto.

For a further example, when the DCI includes a field for indicating a target PUCCH resource, the terminal equipment transmits the PUSCH scheduled by the DCI according to the target PUCCH resource or the antenna panel information related to the PUCCH resource associated with the target PUCCH resource. Here, the target PUCCH resource may be a PUCCH resource that the uplink signal of the terminal equipment follows, that is, the terminal equipment transmits the PUSCH scheduled by the DCI according to the antenna panel information related to the target PUCCH resource. However, this embodiment is not limited thereto, and the target PUCCH resource may also be a PUCCH resource associated with a PUCCH resource that the uplink signal of the terminal equipment follows, that is, the terminal equipment transmits the PUCSH scheduled by the DCI according to the antenna panel information related to the PUCCH resource associated with the target PUCCH resource. A specific association manner is not limited in this embodiment.

In this example, for example, when a value of the above field is “0”, it means that the terminal equipment transmits the uplink signal according to the antenna panel information related to the target PUCCH resource or the PUCCH resource associated with the target PUCCH resource, and when a value of the above field is “1”, it means that the terminal equipment does not transmit the uplink signal according to the antenna panel information related to the target PUCCH resource or the PUCCH resource associated with the target PUCCH resource.

In this example, for another example, the number of bits of the DCI field may be one of 0, 1, 2, 3, 4, 5 and 6, and each codepoint of the field corresponds to an ID of a PUCCH resource, for example, the codepoints correspond to an ascending order of the IDs of the PUCCH resources. Taking that the number of bits of this field is of 2 bits as an example, a codepoint “00” may correspond to a PUCCH resource with an ID “0”, that is, 00→0, and a codepoint “01” may correspond to a target PUCCH resource with an ID “1”, that is, 01→1, a codepoint “10” may correspond to a PUCCH resource with an ID “2”, that is, 10→2, and a codepoint “11” may correspond to a PUCCH resource with an ID “3”, that is, 11→3. Therefore, the terminal equipment may determine a PUCCH resource indicated by the field according to the received DCI, and thus may transmit the uplink signal according to the antenna panel information related to the PUCCH resource.

Each condition of the DCI is explained above. These conditions may be used separately or may be used in a combined manner. For example, DCI with a format of format 0_0 or format 0_1 may also be scrambled by at least one of the above IDs, or include a field used for indicating the target PUCCH resource, and this embodiment is not limited thereto.

In this embodiment, the uplink signal may also be a layer related to a PUSCH, the layer may satisfy at least one of the following conditions:

an ID of the layer is a minimum ID in IDs of layers related to transmission of the PUSCH;

an ID of the layer is a maximum ID in IDs of layers related to transmission of the PUSCH;

an ID of the layer is indicated by a field of DCI;

an ID of the layer is indicated by an MAC CE activation command; and

an ID of the layer is indicated by RRC signaling.

In this embodiment, when the ID of the above layer satisfies at least one of the above conditions, the terminal equipment may transmit the PUSCH according to the antenna panel information related to the PUCCH resource.

For example, when an ID of a layer is the above minimum ID or maximum ID, the terminal equipment transmits the layer according to the antenna panel information related to the PUCCH resource.

For another example, when a field of the DCI indicates an ID of a layer, the terminal equipment transmits the layer indicated by this field of the DCI according to the antenna panel information related to the PUCCH resource. Here, the terminal equipment may also receive the above DCI, and an indication mode of the ID of the above layer, and a receiving mode and contents of the DCI, etc., are not limited in this embodiment.

For a further example, when an MAC CE activation command indicates an ID of a layer, the terminal equipment transmits the layer indicated by the MAC CE activation command according to the antenna panel information related to the PUCCH resource. Here, the terminal equipment may also receive the above MAC CE activation command, and an indication mode of the ID of the above layer, and a receiving mode and contents of the MAC CE activation command, etc., are not limited in this embodiment.

For yet another example, when the RRC signaling indicates a ID of a layer, the terminal equipment transmits the layer indicated by the RRC signaling according to the antenna panel information related to the PUCCH resource. Here, the terminal equipment may also receive the above RRC signaling, and an indication mode of the ID of the above layer, and a receiving mode and contents of the RRC signaling, etc., are not limited in this embodiment.

Each condition of the layer is explained respectively above. These conditions may be used separately or may be used in a combined manner. For example, the ID of the above layer related to the PUSCH is jointly indicated by the RRC signaling and DCI signaling. For example, the RRC signaling indicates a set of layer IDs related to the PUSCH, and thereafter, the DCI signaling indicates an ID in the set; however, this embodiment is not limited thereto.

As for the PUCCH resource in step 201 of this embodiment.

In this embodiment, the PUCCH resource may also be referred to as a PUCCH resource followed by an uplink signal, that is, the terminal equipment transmits the uplink signal according to the antenna panel information related to the PUCCH resource. The PUCCH resource may satisfy at least one of the following conditions:

the PUCCH resource is a PUCCH resource of a minimum ID;

the PUCCH resource is a PUCCH resource of a maximum ID;

a PUCCH resource configured with or associated with antenna panel information;

a PUCCH resource indicated by an RRC signaling;

a PUCCH resource indicated by an MAC CE activation command;

a PUCCH resource indicated by a field of DCI;

a cell where the PUCCH resource is located is at least one of the following cells:
a cell where the uplink signal is transmitted;
an SpCell;
a cell of a minimum ID; and
a cell of a maximum ID; and

the PUCCH resource is a PUCCH resource on an active BWP.

For example, when the terminal equipment transmits an uplink signal, it may transmit the uplink signal according to the antenna panel information related to the PUCCH resource with the minimum or maximum ID in the PUCCH resources. Here, the PUCCH resource with the minimum or maximum ID may be: a PUCCH resource with the minimum or maximum ID in the PUCCH resources (PUCCH resource set) allocated to the terminal equipment, or it may also be a PUCCH resource with the minimum or maximum ID in a part of the PUCCH resources (a PUCCH resource group in a PUCCH resource set) allocated to the terminal equipment. This embodiment is not limited thereto, and the PUCCH resource with the minimum or maximum ID may also be a PUCCH resource with a minimum or maximum ID in other resource sets.

For another example, when the terminal equipment transmits an uplink signal, it may transmit the uplink signal according to the antenna panel information associated with the PUCCH resource configured with or associated with the antenna panel information. In addition, when the PUCCH resource configured with or associated with the antenna panel information is not unique, the terminal equipment may transmit the uplink signal according to antenna panel information associated with a PUCCH resource in PUCCH resources configured with or associated with the antenna panel information (such as a PUCCH resource with a maximum or minimum ID). Here, the PUCCH resource configured with or associated with the antenna panel information may be understood as that: the PUCCH resource is directly configured with the antenna panel information, or a reference signal associated with the PUCCH resource is configured with the antenna panel information.

For a further example, when the terminal equipment transmits an uplink signal, it may also transmit the uplink signal according to antenna panel information related to the PUCCH resource indicated by the RRC signaling. Here, the terminal equipment may also receive RRC signaling, and an indication mode of the PUCCH resource, and contents and a receiving mode of the RRC signaling, etc., are not limited in this embodiment.

For yet another example, when the terminal equipment transmits an uplink signal, it may also transmit the uplink signal according to antenna panel information related to a PUCCH resource indicated by an MAC CE activation command. Here, the terminal equipment may also receive the MAC CE activation command, and an indication mode of the PUCCH resource, and contents and a receiving mode of the MAC CE activation command, etc., are not limited in this embodiment. For example, for a PUCCH resource list configured by RRC signaling, which is referred to as a target PUCCH resource list, the MAC CE activation command may activate one of the PUCCH resources, and the terminal equipment may transmit the uplink signal according to antenna panel information related to a PUCCH resource in the above list activated by the MAC CE activation command.

For still another example, when the terminal equipment transmits an uplink signal, it may also transmit the uplink signal according to antenna panel information related to a PUCCH resource indicated by a field of the DCI. Here, the terminal equipment may also receive the DCI, and an indication mode of the PUCCH resource, and the contents and a receiving mode of the MAC CE activation command, etc., are not limited in this embodiment. For example, the number of bits of the field of the DCI may be one of 0, 1, 2, 3, 4, 5 and 6, and each codepoint of the field corresponds to an ID of a PUCCH resource, for example, the codepoints correspond to an ascending order of the IDs of the PUCCH resources. Taking that the number of bits of this field is of 2 bits as an example, a codepoint “00” may correspond to a PUCCH resource with an ID “0”, that is, 00→0, and a codepoint “01” may correspond to a PUCCH resource with an ID “1”, that is, 01→1, a codepoint “10” may correspond to a PUCCH resource with an ID “2”, that is, 10→2, and a codepoint “11” may correspond to a PUCCH resource with an ID “3”, that is, 11→3. Therefore, the terminal equipment may determine a PUCCH resource indicated by the field according to the received DCI, and thus may transmit the uplink signal according to the antenna panel information related to the PUCCH resource.

For yet still another example, when the terminal equipment transmits an uplink signal, a cell where a PUCCH resource the uplink signal follows satisfies at least one of the following conditions that:

a cell where the uplink signal is transmitted;

an SpCell;

a cell of a minimum ID; and

a cell of a maximum ID.

In this example, the terminal equipment may transmit the uplink signal according to the antenna panel information related to the above PUCCH resource.

For further still another example, when the terminal equipment transmits an uplink signal, it may transmit the uplink signal according to antenna panel information related to a PUCCH resource on an active BWP. A definition and implementation of the active BWP are not limited in this embodiment. Likewise, the terminal equipment may also transmit the uplink signal according to antenna panel information related to a PUCCH resource on a BWP with a maximum or minimum ID.

Each condition of the PUCCH resource is explained respectively above. These conditions may be used separately or may be used in a combined manner, and this embodiment is not limited thereto.

The above description of the uplink signal and the description of the PUCCH resource may be used separately or may be used in a combined manner, and this embodiment is not limited thereto.

In step 201 of this embodiment, the terminal equipment may also transmit an uplink signal according to the antenna panel information related to the PUCCH resource when a condition is satisfied. For example, the terminal equipment may transmit the uplink signal according to the antenna panel information related to the PUCCH resource when a condition related to higher layer signaling is satisfied. The PUCCH resource and the uplink signal have been described above, and contents thereof are incorporated here, which shall not be described herein any further.

In this embodiment, the higher layer signaling may be RRC signaling, or MAC CE activation command, or both, and the condition related to higher layer signaling may be at least one of the following:

a first parameter of the RRC signaling indicates an ID of a target PUCCH resource;

a second parameter of the RRC signaling is set to be “on” or “enabled”;

a third parameter of the RRC signaling is set to be “off” or “disabled”;

a fourth parameter of the RRC signaling is not configured; and

a PUCCH resource in a target PUCCH resource list configured by the RRC signaling is activated by an MAC CE activation command.

For example, when a parameter (referred to as a first parameter) of the RRC signaling indicates an ID of a target PUCCH resource, the terminal equipment transmits the uplink signal according to antenna panel information related to the target PUCCH resource.

In this example, the first parameter is that: if the first parameter is present, the terminal equipment transmits the uplink signal according to antenna panel information associated with the target PUCCH resource, and if the first parameter is absent, the terminal equipment transmits the uplink signal according to antenna panel information associated with a PUCCH resource of a minimum ID on an active BWP. Hence, when the first parameter is present in the RRC signaling, the terminal equipment may transmit the uplink signal according to antenna panel information related to the target PUCCH resource indicated by the first parameter. And when the first parameter is absent in the RRC signaling, the terminal equipment may transmit the uplink signal according to antenna panel information associated with a PUCCH resource with a minimum ID on an active BWP.

In this example, the first parameter may be a parameter in an information element (IE) contained in the RRC signaling, such as “target_PUCCH_Resource”; however, this embodiment is not limited thereto. And a cell where the first parameter is present or on which the first parameter applies may be identical to the cell where the uplink signal is transmitted.

For another example, when a parameter (referred to as a second parameter) of the RRC signaling is set to be “on” or “enabled”, the terminal equipment transmits the uplink signal according to antenna panel information related to a PUCCH resource.

In this example, the second parameter is that: if the second parameter is present and is set to be “on” or “enabled”, the terminal equipment deems that a field used for indicating a target PUCCH resource is absent in DCI; and if the second parameter is absent or is set to be “disabled”, the terminal equipment deems that a field used for indicating a target PUCCH resource is present in DCI. Hence, when the second parameter in the RRC signaling is set to be “on” or “enabled”, the terminal equipment transmits the uplink signal according to antenna panel information related to the above PUCCH resource, and when the second parameter is not contained in the RRC signaling or the second parameter in the RRC signaling is set to be “disabled”, the terminal equipment transmits the uplink signal according to antenna panel information related to the target PUCCH resource indicated by the DCI.

In this example, the second parameter may be a parameter in an IE contained in the RRC signaling, such as “PUSCH_Follow_PUCCH”; however, this embodiment is not limited thereto. And a cell where the second parameter is present or on which the second parameter applies may be identical to the cell where the uplink signal is transmitted.

For another example, when a parameter (referred to as a third parameter) of the RRC signaling is set to be “off” or “disabled”, the terminal equipment transmits the uplink signal according to antenna panel information related to a PUCCH resource.

In this example, the third parameter is that: if the third parameter is present and is set to be “on” or “enabled”, the terminal equipment deems that a field used for indicating a target PUCCH resource is present in DCI; and if the third parameter is absent or is set to be “disabled”, the terminal equipment deems that a field used for indicating a target PUCCH resource is absent in DCI. Hence, when the third parameter in the RRC signaling is set to be “off” or “disabled”, the terminal equipment may transmit the uplink signal according to the antenna panel information related to the above PUCCH resource, and when the third parameter in the RRC signaling is set to be “on” or “enabled”, the terminal equipment may transmit the uplink signal according to the antenna panel information related to the target PUCCH resource indicated by the DCI.

In this example, the third parameter may be an IE contained in the RRC signaling, such as “PUSCH_Not_Follow_PUCCH”; however, this embodiment is not limited thereto. And a cell where the third parameter is present or on which the third parameter applies may be identical to the cell where the uplink signal is transmitted.

For a further example, when a parameter (referred to as a fourth parameter) of the RRC signaling is not configured, the terminal equipment transmits the uplink signal according to antenna panel information related to a PUCCH resource.

In this example, the fourth parameter is that: if the fourth parameter is present and is set to be “on” or “enabled”, the terminal equipment deems that a field used for indicating a target PUCCH resource is present in DCI; and if the fourth parameter is absent or is set to be “disabled”, the terminal equipment deems that a field used for indicating a target PUCCH resource is absent in DCI. Hence, when the fourth parameter is not configured, such as being absent or being set to be “disabled”, the terminal equipment transmits the uplink signal according to antenna panel information related to the above PUCCH resource, and when the fourth parameter is configured, such as being set to be “on” or “enabled”, the terminal equipment transmits the uplink signal according to the antenna panel information related to the target PUCCH resource indicated by the DCI.

In this example, the fourth parameter may be a parameter in an IE contained in the RRC signaling, such as “panel-PresentInDCI”. When the parameter is configured, the terminal equipment transmits the uplink signal according to the antenna panel information related to the PUCCH resource indicated by a field in the DCI, and when the parameter is not configured, the terminal equipment transmits the uplink signal according to the antenna panel information related to the above PUCCH resource. However, this embodiment is not limited thereto, and the IE may also be, for example, “panel_Info”, and when the parameter is configured, the terminal equipment transmits the uplink signal according to antenna panel information provided by the parameter, and when the parameter is not configured, the terminal equipment transmits the uplink signal according to the antenna panel information related to the above PUCCH resource.

In this example, likewise, a cell where the fourth parameter is present or on which the fourth parameter applies may be identical to the cell where the uplink signal is transmitted.

In the above example, a meaning of the target PUCCH resource is identical to what is described above, and shall not be described herein any further.

For a further example, when a PUCCH resource in the target PUCCH resource list configured by the RRC signaling is activated by the MAC CE activation command, the terminal equipment transmits an uplink signal according to antenna panel information related to the activated PUCCH resource. The target PUCCH resource list has been described above, and shall not be described herein any further.

Each condition related to the higher layer signaling is explained respectively above. These conditions may be used separately or may be used in a combined manner, and this embodiment is not limited thereto.

In addition, in this embodiment, the above conditions related to the higher layer signaling may be used separately or may be used in combination with at least one of the above uplink signals, or may be used in combination with at least one of the above PUCCH resources, or may be used in combination with at least one of the above uplink signals and at least one of the above PUCCH resources, and this embodiment is not limited thereto.

In this embodiment, the antenna panel information may be a set of one antenna panel or more than one antenna panels, and one antenna panel may include one or more than one antenna elements. In this embodiment, the antenna panel set may also be understood as an index of one antenna panel or more than one antenna panels, such as an antenna panel port index, or a panel port index, etc. Therefore, the antenna panel information may also be expressed as a set of index(indices) of one antenna panel or more than one antenna panel, or may be expressed as an index of one antenna panel or more than one antenna panel. And furthermore, the antenna panel information may also be understood as antenna panel information associated with a group-based beam report ID.

According to the method of this embodiment, by indicating the antenna panel information related to the uplink control channel resource, the network device may indirectly indicate antenna panel information used in transmitting other uplink signals, thereby achieving joint indication of antenna panel information on control channel and other uplink signals, and saving indication bits (resources).

### Embodiment 2

The embodiment of this disclosure provides an indication method for antenna panel information, applicable to a network device. This method is processing at a network side corresponding to the method in Embodiment 1, with contents identical to those in Embodiment 1 being not going to be described herein any further. FIG. 3 is a schematic diagram of the indication method for antenna panel information of this embodiment. As shown in FIG. 3, the method includes:
step 301: a network device transmits indication information to a terminal equipment, indicating the terminal equipment with antenna panel information related to a PUCCH resource, the terminal equipment transmitting an uplink signal according to the antenna panel information related to a PUCCH resource.

According to the embodiment of this disclosure, by indicating the antenna panel information related to the uplink control channel resource, the network device may indirectly indicate antenna panel information used in transmitting other uplink signals, thereby achieving joint indication of antenna panel information on control channel and other uplink signals, and saving indication bits (resources).

In this embodiment, the network device may further transmit higher layer signaling to the terminal equipment, and the terminal equipment transmits the uplink signal according to the antenna panel information related to a PUCCH resource when a condition related to the higher layer signaling is satisfied.

In this embodiment, the higher layer signaling may be RRC signaling and/or MAC activation command, and the condition related to higher layer signaling may be at least one of the following:

a first parameter of the RRC signaling contains an ID of a target PUCCH resource;

a second parameter of the RRC signaling is set to be “on” or “enabled”;

a third parameter of the RRC signaling is set to be “off” or “disabled”;

a fourth parameter of the RRC signaling is not configured; and

a PUCCH resource in a target PUCCH resource list configured by the RRC signaling is activated by a media access control control element (MAC CE) activation command.

In this embodiment, the first parameter may be defined as that: if the first parameter is present, the terminal equipment transmits the uplink signal according to antenna panel information associated with the target PUCCH resource, and if the first parameter is absent, the terminal equipment transmits the uplink signal according to antenna panel information associated with a PUCCH resource of a minimum ID on a current active BWP.

In this embodiment, the second parameter may be defined as that: if the second parameter is present and is set to be “on” or “enabled”, the terminal equipment deems that a field used for indicating a target PUCCH resource is absent in DCI; and if the second parameter is absent or is set to be “disabled”, the terminal equipment deems that a field used for indicating a target PUCCH resource is present in DCI.

In this embodiment, the third parameter may be defined as that: if the third parameter is present and is set to be “on” or “enabled”, the terminal equipment deems that a field used for indicating a target PUCCH resource is present in DCI; and if the third parameter is absent or is set to be “disabled”, the terminal equipment deems that a field used for indicating a target PUCCH resource is absent in DCI.

In this embodiment, the fourth parameter may be defined as that: if the fourth parameter is present and is set to be “on” or “enabled”, the terminal equipment deems that a field used for indicating a target PUCCH resource is present in DCI; and if the fourth parameter is absent or is set to be “disabled”, the terminal equipment deems that a field used for indicating a target PUCCH resource is absent in DCI.

In this embodiment, cells where the first parameter, the second parameter, the third parameter and the fourth parameter are located or on which they apply may be identical to a cell where the PUSCH is transmitted.

In step 301 of this embodiment, the uplink signal may be a layer related to an uplink data channel (PUSCH), and the layer may satisfy at least one of the following conditions that:

an ID of the layer is a minimum ID in IDs of layers related to transmission of the uplink data channel (PUSCH);

an ID of the layer is a maximum ID in IDs of layers related to transmission of the uplink data channel (PUSCH);

an ID of the layer is indicated by a field of DCI;

an ID of the layer is indicated by an MAC CE activation command; and

an ID of the layer is indicated by RRC signaling.

In step 301 of this embodiment, the uplink signal may be an uplink reference signal. The uplink reference signal may be at least one of the following uplink reference signals:

a periodic SRS;

a semi-persistent SRS; and

an aperiodic SRS.

In step 301 of this embodiment, the uplink signal may be a PUSCH. The PUSCH may be scheduled by the DCI, or may be transmitted according to configuration information. In the case where the PUSCH is scheduled by the DCI, the network device may further transmit the DCI used for scheduling the PUSCH to the terminal equipment, and the DCI may satisfy at least one of the following conditions that:

a format of the DCI is format 0_0 or format 0_1;

the DCI is scrambled by one of a C-RNTI, an MCE-C-RNTI and an RA-RNTI; and

the DCI includes a field used for indicating a target PUCCH resource.

In step 301 of this embodiment, the PUCCH resource may satisfy at least one of the following conditions that:

the PUCCH resource is a PUCCH resource of a minimum ID;

the PUCCH resource is a PUCCH resource of a maximum ID;

a PUCCH resource configured with or associated with antenna panel information;

a PUCCH resource indicated by RRC signaling;

a PUCCH resource indicated by an MAC CE activation command;

a PUCCH resource indicated by a field of DCI;

a cell where the PUCCH resource is located is at least one of the following cells:
a cell where the uplink signal is transmitted;
an SpCell;
a cell of a minimum ID; and
a cell of a maximum ID; and

the PUCCH resource is a PUCCH resource on an active BWP.

In step 301 of this embodiment, the antenna panel information may be any one of the following:

a set of one or more than one antenna panel;

a set of index/indices of one or more than one antenna panel;

an index/indices of one or more than one antenna panel; and

antenna panel information associated with a group-based beam report ID.

According to the method of this embodiment, by indicating the antenna panel information related to the PUCCH resource, the network device may indirectly indicate antenna panel information used in transmitting other uplink signals, thereby achieving joint indication of antenna panel information on control channel and other uplink signals, and saving indication bits (resources).

### Embodiment 3

The embodiment of this disclosure provides a signal transmission apparatus, configured in a terminal equipment. As principles of the apparatus for solving problems are similar to that of the method in Embodiment 1, reference may be made to the implementation of the method in Embodiment 1 for implementation of this apparatus, with identical contents being not going to be described herein any further.

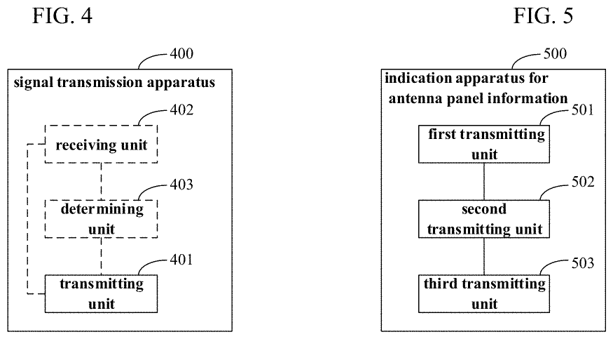

FIG. 4 is a schematic diagram of the signal transmission apparatus of this embodiment. Referring to FIG. 4, a signal transmission apparatus 400 includes a transmitting unit 401 configured to transmit an uplink signal according to antenna panel information related to an uplink control channel (PUCCH) resource.

In this embodiment, when a condition related to higher layer signaling is satisfied, the transmitting unit 401 transmits the uplink signal according to the antenna panel information related to an uplink control channel (PUCCH) resource. As shown in FIG. 4, the apparatus 400 may further include a receiving unit 402 and a determining unit 403. The receiving unit 402 may receive the above higher layer signaling, and the determining unit 403 may determine whether the condition related to the higher layer signaling is satisfied.

In this embodiment, the higher layer signaling may be RRC signaling and/or MAC activation command, and the condition related to higher layer signaling may be at least one of the following that:

a first parameter of the RRC signaling indicates an ID of a target PUCCH resource;

a second parameter of the RRC signaling is set to be “on” or “enabled”;

a third parameter of the RRC signaling is set to be “off” or “disabled”;

a fourth parameter of the RRC signaling is not configured; and

a PUCCH resource in a target PUCCH resource list configured by the RRC signaling is activated by a media access control control element activation command.

In this embodiment, the first parameter may be defined as that: if the first parameter is present, the terminal equipment transmits the uplink signal according to antenna panel information associated with a target PUCCH resource, and if the first parameter is absent, the terminal equipment transmits the uplink signal according to antenna panel information associated with a PUCCH resource of a minimum ID on an active BWP.

In this embodiment, the second parameter may be defined as that: if the second parameter is present and is set to be “on” or “enabled”, the terminal equipment deems that a field used for indicating a target PUCCH resource is absent in DCI; and if the second parameter is absent or is set to be “disabled”, the terminal equipment deems that a field used for indicating a target PUCCH resource is present in DCI.

In this embodiment, the third parameter may be defined as that: if the third parameter is present and is set to be “on” or “enabled”, the terminal equipment deems that a field used for indicating a target PUCCH resource is present in DCI; and if the third parameter is absent or is set to be “disabled”, the terminal equipment deems that a field used for indicating a target PUCCH resource is absent in DCI.

In this embodiment, the fourth parameter may be defined as that: if the fourth parameter is present and is set to be “on” or “enabled”, the terminal equipment deems that a field used for indicating a target PUCCH resource is present in DCI; and if the fourth parameter is absent or is set to be “disabled”, the terminal equipment deems that a field used for indicating a target PUCCH resource is absent in DCI.

In this embodiment, cells where the first parameter, the second parameter, the third parameter and the fourth parameter are located or on which they apply are identical to a cell where the uplink signal is transmitted.

In this embodiment, the uplink signal may be a layer related to an uplink data channel (PUSCH), the layer here satisfying at least one of the following conditions that:

an ID of the layer is a minimum ID in IDs of layers related to transmission of the uplink data channel (PUSCH);

an ID of the layer is a maximum ID in IDs of layers related to transmission of the uplink data channel (PUSCH);

an ID of the layer is indicated by a field of DCI;

an ID of the layer is indicated by an MAC CE activation command; and

an ID of the layer is indicated by RRC signaling.

In this embodiment, the uplink signal may be an uplink reference signal. For example, the uplink reference signal may be at least one of the following uplink reference signals:

a periodic SRS;

a semi-persistent SRS; and

an aperiodic SRS.

In this embodiment, the uplink signal may be a PUSCH, and the PUSCH may be scheduled by DCI, the DCI may satisfy at least one of the following conditions that:

a format of the DCI is format 0_0 or format 0_1;

the DCI is scrambled by one of a C-RNTI, an MCE-C-RNTI and an RA-RNTI; and

the DCI includes a field used for indicating a target PUCCH resource.

In this embodiment, the uplink control channel (PUCCH) resource may satisfy at least one of the following conditions that:

the PUCCH resource is a PUCCH resource of a minimum ID;

the PUCCH resource is a PUCCH resource of a maximum ID;

a PUCCH resource configured with or associated with antenna panel information;

a PUCCH resource indicated by RRC signaling;

a PUCCH resource indicated by an MAC CE activation command;

a PUCCH resource indicated by a field of DCI;

a cell where the PUCCH resource is located is at least one of the following cells:
a cell where the uplink signal is transmitted;
an SpCell;
a cell of a minimum ID; and
a cell of a maximum ID; and

the PUCCH resource is a PUCCH resource on an active BWP.

In this embodiment, the antenna panel information may be any one of the following:

a set of one or more than one antenna panel;

a set of index/indices of one or more than one antenna panel;

an index/indices of one or more than one antenna panels; and

antenna panel information associated with a group-based beam report ID.

In this embodiment, the receiving unit 402 may also receive the RRC signaling and/or MAC CE activation command and/or DCI, and the determining unit 403 may also determine whether the above conditions are satisfied according to the various signaling received by the receiving unit 402, or the transmitting unit 401 may obtain the above various information according to the various signaling received by the receiving unit 402, which shall not be described herein any further.

According to the apparatus of this embodiment, by indicating the antenna panel information related to the uplink control channel resource, the network device may indirectly indicate antenna panel information used in transmitting other uplink signals, thereby achieving joint indication of antenna panel information on control channel and other uplink signals, and saving indication bits (resources).

### Embodiment 4

The embodiment of this disclosure provides an indication apparatus for antenna panel information, configured in a network. As principles of the apparatus for solving problems are similar to that of the method in Embodiment 2, reference may be made to the implementation of the method in Embodiment 2 for implementation of this apparatus, with identical contents being not going to be described herein any further.

FIG. 5 is a schematic diagram of the indication apparatus for antenna panel information of this embodiment. As shown in FIG. 5, an indication apparatus 500 for antenna panel information includes a first transmitting unit 501 configured to transmit indication information to a terminal equipment, indicating the terminal equipment with antenna panel information related to a PUCCH resource, the terminal equipment transmitting an uplink signal according to the antenna panel information related to a PUCCH resource.

In this embodiment, as shown in FIG. 5, the apparatus 500 may further include:

a second transmitting unit 502 configured to transmit higher layer signaling to the terminal equipment, the terminal equipment transmitting the uplink signal according to the antenna panel information related to a PUCCH resource when a condition related to the higher layer signaling is satisfied.

In this embodiment, the higher layer signaling may be RRC signaling and/or MAC activation command, and the condition related to higher layer signaling may be at least one of the following that:

a first parameter of the RRC signaling indicates an ID of a target PUCCH resource;

a second parameter of the RRC signaling is set to be “on” or “enabled”;

a third parameter of the RRC signaling is set to be “off” or “disabled”;

a fourth parameter of the RRC signaling is not configured; and

a PUCCH resource in a target PUCCH resource list configured by the RRC signaling is activated by a media access control control element (MAC CE) activation command.

In this embodiment, the first parameter may be defined as that: if the first parameter is present, the terminal equipment transmits the uplink signal according to antenna panel information associated with the target PUCCH resource, and if the first parameter is absent, the terminal equipment transmits the uplink signal according to antenna panel information associated with a PUCCH resource of a minimum ID on an active BWP.

In this embodiment, the second parameter may be defined as that: if the second parameter is present and is set to be “on” or “enabled”, the terminal equipment deems that a field used for indicating a target PUCCH resource is absent in DCI; and if the second parameter is absent or is set to be “disabled”, the terminal equipment deems that a field used for indicating a target PUCCH resource is present in DCI.

In this embodiment, the third parameter may be defined as that: if the third parameter is present and is set to be “on” or “enabled”, the terminal equipment deems that a field used for indicating a target PUCCH resource is present in DCI; and if the third parameter is absent or is set to be “disabled”, the terminal equipment deems that a field used for indicating a target PUCCH resource is absent in DCI.

In this embodiment, the fourth parameter may be defined as that: if the fourth parameter is present and is set to be “on” or “enabled”, the terminal equipment deems that a field used for indicating a target PUCCH resource is present in DCI; and if the fourth parameter is absent or is set to be “disabled”, the terminal equipment deems that a field used for indicating a target PUCCH resource is absent in DCI.

In this embodiment, cells where the first parameter, the second parameter, the third parameter and the fourth parameter are located or on which they apply are identical to a cell where the PUSCH is transmitted.

In this embodiment, the uplink signal may be a layer related to an uplink data channel (PUSCH), the layer may satisfy at least one of the following conditions that:

an ID of the layer is a minimum ID in IDs of layers related to transmission of the uplink data channel (PUSCH);

an ID of the layer is a maximum ID in IDs of layers related to transmission of the uplink data channel (PUSCH);

an ID of the layer is indicated by a field of DCI;

an ID of the layer is indicated by an MAC CE activation command; and

an ID of the layer is indicated by RRC signaling.

In this embodiment, the uplink signal may be an uplink reference signal. For example, the uplink reference signal may be at least one of the following uplink reference signals:

a periodic SRS;

a semi-persistent SRS; and

an aperiodic SRS.

In this embodiment, the uplink signal may be a PUSCH, the PUSCH may be scheduled by DCI, or the PUSCH may be transmitted according to configuration information. As shown in FIG. 5, when the PUSCH is scheduled by DCI, the apparatus 500 may further include:

a third transmitting unit 503 configured to transmit DCI used for scheduling the PUSCH to the terminal equipment, the DCI may satisfy at least one of the following conditions:

a format of the DC is format 0_0 or format 0_1;

the DCI is scrambled by one of a C-RNTI, an MCE-C-RNTI and an RA-RNTI; and

the DCI includes a field used for indicating a target PUCCH resource.

In this embodiment, the uplink control channel (PUCCH) resource may satisfy at least one of the following conditions that:

the PUCCH resource is a PUCCH resource of a minimum ID;

the PUCCH resource is a PUCCH resource of a maximum ID;

a PUCCH resource configured with or associated with antenna panel information;

a PUCCH resource indicated by RRC signaling;

a PUCCH resource indicated by an MAC CE activation command;

a PUCCH resource indicated by a field of DCI;

a cell where the PUCCH resource is located is at least one of the following cells:
a cell where the uplink signal is transmitted;
an SpCell;
a cell of a minimum ID; and
a cell of a maximum ID; and

the PUCCH resource is a PUCCH resource on an active BWP.

In this embodiment, the antenna panel information may be any one of the following:

a set of one or more than one antenna panel;

a set of index/indices of one or more than one antenna panel;

an index/indices of one or more than one antenna panel; and

antenna panel information associated with a group-based beam report ID.

According to the apparatus of this embodiment, by only indicating the antenna panel information related to the PUCCH resource, the network device may indirectly indicate antenna panel information used in transmitting other uplink signals, thereby achieving joint indication of antenna panel information on control channel and other uplink signals, and saving indication bits (resources).

### Embodiment 5

The embodiment of this disclosure provides a terminal equipment, including the apparatus as described in Embodiment 3.

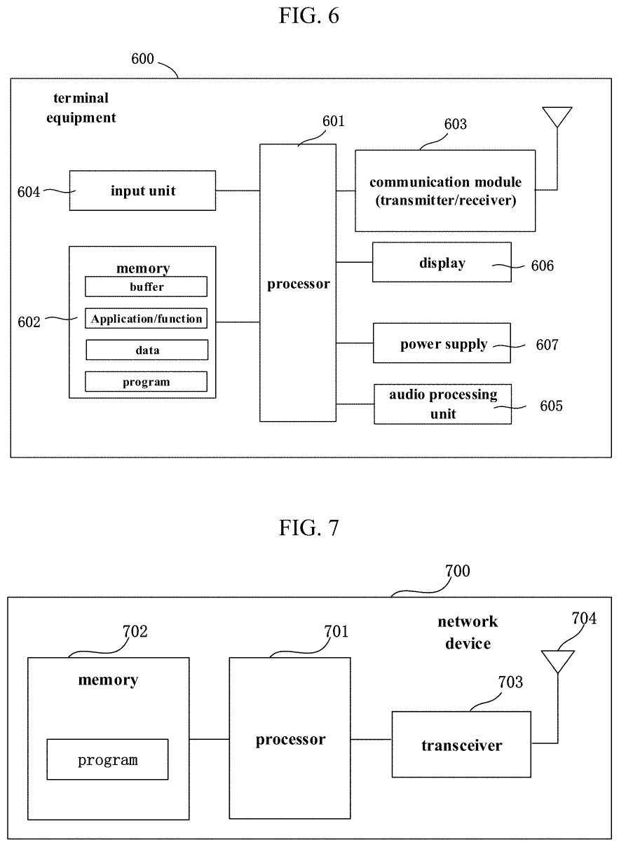

FIG. 6 is a schematic diagram of the terminal equipment of the embodiment of this disclosure. As shown in FIG. 6, a terminal equipment 600 may include a central processor 601 and a memory 602, the memory 602 being coupled to the central processor 601. It should be noted that this figure is illustrative only, and other types of structures may also be used, so as to supplement or replace this structure and achieve a telecommunications function or other functions.

In one implementation, the functions of the apparatus described in Embodiment 3 may be integrated into the central processor 601, and the functions of the apparatus described in Embodiment 3 are carried out by the central processor 601; wherein the functions of the apparatus described in Embodiment 3 are incorporated herein, and shall not be described herein any further.

In another implementation, the apparatus described in Embodiment 3 and the central processor 601 may be configured separately; for example, the apparatus described in Embodiment 3 may be configured as a chip connected to the central processor 601, and the functions of the apparatus described in Embodiment 3 are executed under control of the central processor 601.

As shown in FIG. 6, the terminal equipment 600 may further include a communication module 603, an input unit 604, an audio processing unit 605, a display 606, and a power supply 607. It should be noted that the terminal equipment 600 does not necessarily include all the parts shown in FIG. 6. Furthermore, the terminal equipment 600 may include parts not shown in FIG. 6, and the related art may be referred to.

As shown in FIG. 6, the central processor 601 is sometimes referred to as a controller or control, which may include a microprocessor or other processor devices and/or logic devices, and the central processor 601 receives input and controls operations of every component of the terminal equipment 600.

The memory 602 may be, for example, one or more of a buffer memory, a flash memory, a hard drive, a mobile medium, a volatile memory, a nonvolatile memory, or other suitable devices, which may store the information on configuration, etc., and furthermore, store programs executing related information. And the central processor 601 may execute programs stored in the memory 602, so as to realize information storage or processing, etc. Functions of other parts are similar to those of the related art, which shall not be described herein any further. The parts of the terminal equipment 600 may be realized by specific hardware, firmware, software, or any combination thereof, without departing from the scope of this disclosure.

With the terminal equipment of this embodiment, indication bits (resources) may be saved.

### Embodiment 6

The embodiment of this disclosure provides a network device, including the apparatus as described in Embodiment 4.

FIG. 7 is a schematic diagram of a structure of one implementation of the network device of the embodiment of this disclosure. As shown in FIG. 7, a network device 700 may include a central processor (CPU) 701 and a memory 702, the memory 702 being coupled to the central processor 701. The memory 702 may store various data, and furthermore, it may store a program for data processing, and execute the program under control of the central processor 701, so as to receive various information transmitted by a terminal equipment and transmit various information to the terminal equipment.

In one implementation, the functions of the apparatus described in Embodiment 4 may be integrated into the central processor 701, and the functions of the apparatus described in Embodiment 4 are carried out by the central processor 701; wherein the functions of the apparatus described in Embodiment 4 are incorporated herein, and shall not be described herein any further.

In another implementation, the apparatus described in Embodiment 4 and the central processor 701 may be configured separately; for example, the apparatus described in Embodiment 4 may be configured as a chip connected to the central processor 701, and the functions of the apparatus described in Embodiment 4 are executed under control of the central processor 701.

Furthermore, as shown in FIG. 7, the network device 700 may include a transceiver 703, and an antenna 704, etc. Functions of the above components are similar to those in the related art, and shall not be described herein any further. It should be noted that the network device 700 does not necessarily include all the parts shown in FIG. 7, and furthermore, the network device 700 may include parts not shown in FIG. 7, and the related art may be referred to.

With the network device of this embodiment, indication bits (resources) may be saved.

### Embodiment 7

The embodiment of this disclosure provides a communication system, including a network device and a terminal equipment, the network device being, for example, the network device 700 described in Embodiment 6, and the terminal equipment being, for example, the terminal equipment 600 described in Embodiment 5.

In this embodiment, the terminal equipment is, for example, a UE served by a gNB, and includes conventional compositions and functions of a terminal equipment, in addition to the functions of the apparatus described in Embodiment 3, which are as described in Embodiment 5, and shall not be described herein any further.

In this embodiment, the network device may be, for example, a gNB in NR, and includes conventional compositions and functions of a network device, in addition to the functions of the apparatus described in Embodiment 4, which are as described in Embodiment 6, and shall not be described herein any further.

With the communication system of this embodiment, indication bits (resources) may be saved.

An embodiment of this disclosure provides a computer readable program, which, when executed in a terminal equipment, will cause a computer to carry out the method described in Embodiment 1 in the terminal equipment.

An embodiment of this disclosure provides a storage medium storing a computer readable program, which will cause a computer to carry out the method described in Embodiment 1 in a terminal equipment.

An embodiment of this disclosure provides a computer readable program, which, when executed in a network device, will cause a computer to carry out the method described in Embodiment 2 in the network device.

An embodiment of this disclosure provides a storage medium storing a computer readable program, which will cause a computer to carry out the method described in Embodiment 2 in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules.

Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

For implementations of this disclosure containing the above embodiments, following supplements are further disclosed.

1. A signal transmission apparatus, configured in a terminal equipment, the apparatus including:

a transmitting unit configured to transmit an uplink signal according to antenna panel information related to an uplink control channel (PUCCH) resource.

2. The apparatus according to supplement 1, wherein when a condition related to higher layer signaling is satisfied, the transmitting unit transmits the uplink signal according to the antenna panel information related to an uplink control channel (PUCCH) resource.

3. The apparatus according to supplement 2, wherein the higher layer signaling is RRC signaling and/or an MAC activation command, and the condition related to higher layer signaling is at least one of the following that:

a first parameter of the RRC signaling indicates an ID of a target PUCCH resource;

a second parameter of the RRC signaling is set to be “on” or “enabled”;

a third parameter of the RRC signaling is set to be “off” or “disabled”;

a fourth parameter of the RRC signaling is not configured; and

a PUCCH resource in a target PUCCH resource list configured by the RRC signaling is activated by a media access control control element activation command.

4. The apparatus according to supplement 3, wherein the first parameter is that: if the first parameter is present, the terminal equipment transmits the uplink signal according to antenna panel information associated with the target PUCCH resource, and if the first parameter is absent, the terminal equipment transmits the uplink signal according to antenna panel information associated with a PUCCH resource of a minimum ID on an active BWP.

5. The apparatus according to supplement 3, wherein the second parameter is that: if the second parameter is present and is set to be “on” or “enabled”, the terminal equipment deems that a field used for indicating a target PUCCH resource is absent in DCI; and if the second parameter is absent or is set to be “disabled”, the terminal equipment deems that a field used for indicating a target PUCCH resource is present in DCI.

6. The apparatus according to supplement 3, wherein the third parameter is that: if the third parameter is present and is set to be “on” or “enabled”, the terminal equipment deems that a field used for indicating a target PUCCH resource is present in DCI; and if the third parameter is absent or is set to be “disabled”, the terminal equipment deems that a field used for indicating a target PUCCH resource is absent in DCI.

7. The apparatus according to supplement 3, wherein the fourth parameter is that: if the fourth parameter is present and is set to be “on” or “enabled”, the terminal equipment deems that a field used for indicating a target PUCCH resource is present in DCI; and if the fourth parameter is absent or is set to be “disabled”, the terminal equipment deems that a field used for indicating a target PUCCH resource is absent in DCI.

8. The apparatus according to supplement 3, wherein cells where the first parameter, the second parameter, the third parameter and the fourth parameter are located or on which they apply are identical to a cell where the uplink signal is transmitted.

9. The apparatus according to supplement 1, wherein the uplink signal is a layer related to an uplink data channel (PUSCH), the layer satisfying at least one of the following conditions that:

an ID of the layer is a minimum ID in IDs of layers related to transmission of the uplink data channel (PUSCH);

an ID of the layer is a maximum ID in IDs of layers related to transmission of the uplink data channel (PUSCH);

an ID of the layer is indicated by a field of DCI;

an ID of the layer is indicated by an MAC CE activation command; and

an ID of the layer is indicated by an RRC signaling.

10. The apparatus according to supplement 1, wherein the uplink signal is an uplink reference signal.

11. The apparatus according to supplement 10, wherein the uplink reference signal is at least one of the following uplink reference signals:

a periodic SRS;

a semi-persistent SRS; and

an aperiodic SRS.

12. The apparatus according to supplement 1, wherein the uplink signal is a PUSCH.

13. The apparatus according to supplement 12, wherein the PUSCH is scheduled by DCI, the DCI satisfying at least one of the following conditions that:

a format of the DCI is format 0_0 or format 0_1;

the DCI is scrambled by one of a C-RNTI, an MCE-C-RNTI and an RA-RNTI; and the DCI includes a field used for indicating a target PUCCH resource.

14. The apparatus according to supplement 1, wherein the uplink control channel (PUCCH) resource satisfies at least one of the following conditions that:

the PUCCH resource is a PUCCH resource of a minimum ID;

the PUCCH resource is a PUCCH resource of a maximum ID;

a PUCCH resource configured with or associated with antenna panel information;

a PUCCH resource indicated by RRC signaling;

a PUCCH resource indicated by an MAC CE activation command;

a PUCCH resource indicated by a field of DCI;

a cell where the PUCCH resource is located is at least one of the following cells:
a cell where the uplink signal is transmitted;
an SpCell;
a cell of a minimum ID; and
a cell of a maximum ID; and

the PUCCH resource is a PUCCH resource on an active BWP.

15. The apparatus according to supplement 1, wherein the antenna panel information is any one of the following:

a set of one or more than one antenna panel;

a set of index/indices of one or more than one antenna panel;

an index/indices of one or more than one antenna panels; and

antenna panel information associated with a group-based beam report ID.

1A. An indication apparatus for antenna panel information, configured in a network device, the apparatus including:

a first transmitting unit configured to transmit indication information to a terminal equipment, indicating the terminal equipment with antenna panel information related to a PUCCH resource, the terminal equipment transmitting an uplink signal according to the antenna panel information related to a PUCCH resource.

2A. The apparatus according to supplement 1A, wherein the apparatus further includes:

a second transmitting unit configured to transmit higher layer signaling to the terminal equipment, the terminal equipment transmitting the uplink signal according to the antenna panel information related to a PUCCH resource when a condition related to the higher layer signaling is satisfied.

3A. The apparatus according to supplement 2A, wherein the higher layer signaling is RRC signaling and/or an MAC activation command, and the condition related to higher layer signaling is at least one of the following:

a first parameter of the RRC signaling indicates an ID of a target PUCCH resource;

a second parameter of the RRC signaling is set to be “on” or “enabled”;

a third parameter of the RRC signaling is set to be “off” or “disabled”;

a fourth parameter of the RRC signaling is not configured; and

a PUCCH resource in a target PUCCH resource list configured by the RRC signaling is activated by a media access control control element (MAC CE) activation command.

4A. The apparatus according to supplement 3A, the first parameter is that: if the first parameter is present, the terminal equipment transmits the uplink signal according to antenna panel information associated with the target PUCCH resource, and if the first parameter is absent, the terminal equipment transmits the uplink signal according to antenna panel information associated with a PUCCH resource of a minimum ID on an active BWP.

5A. The apparatus according to supplement 3A, wherein the second parameter is that: if the second parameter is present and is set to be “on” or “enabled”, the terminal equipment deems that a field used for indicating a target PUCCH resource is absent in DCI; and if the second parameter is absent or is set to be “disabled”, the terminal equipment deems that a field used for indicating a target PUCCH resource is present in DCI.

6A. The apparatus according to supplement 3A, wherein the third parameter is that: if the third parameter is present and is set to be “on” or “enabled”, the terminal equipment deems that a field used for indicating a target PUCCH resource is present in DCI; and if the third parameter is absent or is set to be “disabled”, the terminal equipment deems that a field used for indicating a target PUCCH resource is absent in DCI.

7A. The apparatus according to supplement 3A, wherein the fourth parameter is that: if the fourth parameter is present and is set to be “on” or “enabled”, the terminal equipment deems that a field used for indicating a target PUCCH resource is present in DCI; and if the fourth parameter is absent or is set to be “disabled”, the terminal equipment deems that a field used for indicating a target PUCCH resource is absent in DCI.

8A. The apparatus according to supplement 3A, wherein cells where the first parameter, the second parameter, the third parameter and the fourth parameter are located or on which they apply are identical to a cell where the uplink signal is transmitted.

9A. The apparatus according to supplement 1A, wherein the uplink signal is a layer related to an uplink data channel (PUSCH), the layer satisfying at least one of the following conditions that:

an ID of the layer is a minimum ID in IDs of layers related to transmission of the uplink data channel (PUSCH);

an ID of the layer is a maximum ID in IDs of layers related to transmission of the uplink data channel (PUSCH);

an ID of the layer is indicated by a field of DCI;

an ID of the layer is indicated by an MAC CE activation command; and

an ID of the layer is indicated by RRC signaling.

10A. The apparatus according to supplement IA, wherein the uplink signal is an uplink reference signal.

11A. The apparatus according to supplement 10A, wherein the uplink reference signal is at least one of the following uplink reference signals:

a periodic SRS;

a semi-persistent SRS; and

an aperiodic SRS.

12A. The apparatus according to supplement IA, wherein the uplink signal is a PUSCH.

13A. The apparatus according to supplement 12A, wherein the apparatus further includes:

a third transmitting unit configured to transmit DCI used for scheduling the PUSCH to the terminal equipment, the DCI satisfying at least one of the following conditions:

a format of the DCI is format 0_0 or format 0_1;

the DCI is scrambled by one of a C-RNTI, an MCE-C-RNTI and an RA-RNTI; and

the DCI includes a field used for indicating a target PUCCH resource.

14A. The apparatus according to supplement 1A, wherein the uplink control channel (PUCCH) resource satisfies at least one of the following conditions that:

the PUCCH resource is a PUCCH resource of a minimum ID;

the PUCCH resource is a PUCCH resource of a maximum ID;

a PUCCH resource configured with or associated with antenna panel information;

a PUCCH resource indicated by RRC signaling;

a PUCCH resource indicated by an MAC CE activation command;

a PUCCH resource indicated by a field of DCI;

a cell where the PUCCH resource is located is at least one of the following cells:
a cell where the uplink signal is transmitted;
an SpCell;
a cell of a minimum ID; and
a cell of a maximum ID; and

the PUCCH resource is a PUCCH resource on an active BWP.

15A. The apparatus according to supplement 1A, wherein the antenna panel information is any one of the following:

a set of one or more than one antenna panel;

a set of index/indices of one or more than one antenna panel;

an index/indices of one or more than one antenna panel; and

antenna panel information associated with a group-based beam report ID.

1B. A communication system, including a terminal equipment and a network device, the terminal equipment including the apparatus as described in any one of supplements 1-15, and the network device including the apparatus as described in any one of supplements 1A-15A.

What is claimed is:

1. A signal transmission apparatus, configured in a terminal equipment, the apparatus comprising:
a transmitter configured to transmit an uplink signal according to antenna panel information related to an uplink control channel (PUCCH) resource.

2. The apparatus according to claim 1, wherein when a condition related to higher layer signaling is satisfied, the transmitter transmits the uplink signal according to the antenna panel information related to an uplink control channel (PUCCH) resource.

3. The apparatus according to claim 2, wherein the higher layer signaling is RRC signaling and/or an MAC activation command, and the condition related to higher layer signaling is at least one of the following:
a first parameter of the RRC signaling indicates an identifier (ID) of a target PUCCH resource;
a second parameter of the RRC signaling is set to be “on” or “enabled”;
a third parameter of the RRC signaling is set to be “off” or “disabled”;
a fourth parameter of the RRC signaling is not configured; and
a PUCCH resource in a target PUCCH resource list configured by the RRC signaling is activated by a media access control control element activation command.

4. The apparatus according to claim 3, wherein cells where the first parameter, the second parameter, the third parameter and the fourth parameter are located or on which they apply are identical to a cell where the uplink signal is transmitted.

5. The apparatus according to claim 1, wherein the uplink signal is a layer related to an uplink data channel (PUSCH), the layer satisfying at least one of the following conditions:
an ID of the layer is a minimum ID in IDs of layers related to transmission of the uplink data channel (PUSCH);
an ID of the layer is a maximum ID in IDs of layers related to transmission of the uplink data channel (PUSCH);
an ID of the layer is indicated by a field of DCI;
an ID of the layer is indicated by an MAC CE activation command; and
an ID of the layer is indicated by RRC signaling.

6. The apparatus according to claim 1, wherein the uplink signal is an uplink reference signal.

7. The apparatus according to claim 6, wherein the uplink reference signal is at least one of the following uplink reference signals:
a periodic SRS;
a semi-persistent SRS; and
an aperiodic SRS.

8. The apparatus according to claim 1, wherein the uplink signal is an uplink data channel (PUSCH).

9. The apparatus according to claim 8, wherein the PUSCH is scheduled by DCI, the DCI satisfying at least one of the following conditions:
a format of the DCI is format 0_0 or format 0_1;
the DCI is scrambled by one of a C-RNTI, an MCE-C-RNTI and an RA-RNTI; and
the DCI comprises a field used for indicating a target PUCCH resource.

10. The apparatus according to claim 1, wherein the uplink control channel (PUCCH) resource satisfies at least one of the following conditions:
the PUCCH resource is a PUCCH resource of a minimum ID;
the PUCCH resource is a PUCCH resource of a maximum ID;
a PUCCH resource configured with or associated with antenna panel information;
a PUCCH resource indicated by RRC signaling;
a PUCCH resource indicated by an MAC CE activation command;
a PUCCH resource indicated by a field of DCI;
a cell where the PUCCH resource is located is at least one of the following cells:
a cell where the uplink signal is transmitted;
an SpCell;
a cell of a minimum ID; and
a cell of a maximum ID; and
the PUCCH resource is a PUCCH resource on an active BWP.

11. An indication apparatus for antenna panel information, configured in a network device, the apparatus comprising:
a first transmitter configured to transmit indication information to a terminal equipment, indicating the terminal equipment with antenna panel information related to a PUCCH resource, the terminal equipment transmitting an uplink signal according to the antenna panel information related to a PUCCH resource.

12. The apparatus according to claim 11, wherein the apparatus further comprises:
a second transmitter configured to transmit higher layer signaling to the terminal equipment, the terminal equipment transmitting the uplink signal according to the antenna panel information related to a PUCCH resource when a condition related to the higher layer signaling is satisfied.

13. The apparatus according to claim 12, wherein the higher layer signaling is RRC signaling and/or an MAC activation command, and the condition related to higher layer signaling is at least one of the following:
a first parameter of the RRC signaling indicates an ID of a target PUCCH resource;
a second parameter of the RRC signaling is set to be on or enabled;
a third parameter of the RRC signaling is set to be off or disabled;
a fourth parameter of the RRC signaling is not configured; and
a PUCCH resource in a target PUCCH resource list configured by the RRC signaling is activated by a media access control control element (MAC CE) activation command.

14. The apparatus according to claim 13, wherein cells where the first parameter, the second parameter, the third parameter and the fourth parameter are located or on which they apply are identical to a cell where the uplink signal is transmitted.

15. The apparatus according to claim 11, wherein the uplink signal is a layer related to an uplink data channel (PUSCH), the layer satisfying at least one of the following conditions:
an ID of the layer is a minimum ID in IDs of layers related to transmission of the uplink data channel (PUSCH);
an ID of the layer is a maximum ID in IDs of layers related to transmission of the uplink data channel (PUSCH);
an ID of the layer is indicated by a field of DCI;
an ID of the layer is indicated by an MAC CE activation command; and
an ID of the layer is indicated by RRC signaling.

16. The apparatus according to claim 11, wherein the uplink signal is an uplink reference signal.

17. The apparatus according to claim 16, wherein the uplink reference signal is at least one of the following uplink reference signals:
a periodic SRS;
a semi-persistent SRS; and
an aperiodic SRS.

18. The apparatus according to claim 11, wherein the uplink signal is an uplink data channel (PUSCH).

19. The apparatus according to claim 18, wherein the apparatus further comprises:
a third transmitter configured to transmit DCI used for scheduling the PUSCH to the terminal equipment, the DCI satisfying at least one of the following conditions:
a format of the DCI is format 0_0 or format 0_1;
the DCI is scrambled by one of a C-RNTI, an MCE-C-RNTI and an RA-RNTI; and
the DCI comprises a field used for indicating a target PUCCH resource.

20. The apparatus according to claim 11, wherein the uplink control channel (PUCCH) resource satisfies at least one of the following conditions:
the PUCCH resource is a PUCCH resource of a minimum ID;
the PUCCH resource is a PUCCH resource of a maximum ID;
a PUCCH resource configured with or associated with antenna panel information;
a PUCCH resource indicated by RRC signaling;
a PUCCH resource indicated by an MAC CE activation command;
a PUCCH resource indicated by a field of DCI;
a cell where the PUCCH resource is located is at least one of the following cells:
a cell where the uplink signal is transmitted;
an SpCell;
a cell of a minimum ID; and
a cell of a maximum ID; and
the PUCCH resource is a PUCCH resource on an active BWP.
